(19) United States
(12) Patent Application Publication
(10) Pub. No.: US 2014/0189830 A1
(43) Pub. Date: Jul. 3, 2014

(54) Multi-Component Signature Generation

(71) Applicant: INTERNATIONAL BUSINESS MACHINES CORPORATION, Armonk, NY (US)

(72) Inventor: Scott R. Crarrier, Apex, NC (US)

(73) Assignee: International Business Machines Corporation, Armonk, NY (US)

(21) Appl. No.: 13/732,648

(22) Filed: Jan. 2, 2013

(51) Int. Cl. H04L 29/06

(52) U.S. Cl. CPC H04L 63/10
USPC 726/6

(57) ABSTRACT

A method, system, and computer program product for multi-component signature generation are provided in the illustrative embodiments. A set of original signature components is received comprising original signature components of different types. A subset of original signature components from the set of original signature components is modified to create a set of modified signature components. Members of a subset of the set of modified signature components are arranged in a modified order. The modified order is different from an original order in which original signature components corresponding to the members of the subset of the set of modified signature components appear in the set of original signature components. The multi-component signature is generated in response to the arranging.

### BACKGROUND

1. Technical Field

The present invention relates generally to a method, system, and computer program product for generating data usable as signature. More particularly, the present invention relates to a method, system, and computer program product for complex multi-component signature generation.

2. Description of the Related Art

A signature is data usable for authorizing, authenticating, approving, or generally identifying a user, such as a person, an application, or a data processing system. Hand-scripted signatures are commonplace on paper documents. Biometric data, such as an individual's fingerprint, is commonly used for identification. Alphanumeric strings of certain lengths are commonly used in digital signatures and certificates.

Technology exists for accepting as a user's signature a pattern drawn by the user using a pointing device, such as a stylus or a finger-tip. Technology also exists for accepting as a user's signature a gesture made by a user with respect to a device, such as by swiping across a screen of the device.

### SUMMARY

The illustrative embodiments provide a method, system, and computer program product for multi-component signature generation. At least one embodiment includes receiving, at an application executing using a processor, a set of original signature components comprising original signature components of different types. The embodiment further includes modifying a subset of original signature components from the set of original signature components to create a set of modified signature components. The embodiment further includes arranging members of a subset of the set of modified signature components in a modified order, wherein the modified order is different from an original order in which original signature components corresponding to the members of the subset of the set of modified signature components appear in the set of original signature components. The embodiment further includes generating, responsive to the arranging, the multi-component signature.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of an application for multi-component signature generation in accordance with an illustrative embodiment;

FIG. 4 depicts an example multi-component signature generated from several inputs, events, and states in accordance with an illustrative embodiment; and

FIG. 5 depicts a flowchart of an example process for multi-component signature generation in accordance with an illustrative embodiment.

### DETAILED DESCRIPTION

The illustrative embodiments recognize that presently used methods for generating digital signatures rely on a single-mode input for generating the signature. For example, the presently used methods rely on a user to provide a single input, such as a gesture, a key press, or data-entry, which is then matched with a stored corresponding gesture data, key press data, or the text of the data entry. If a presently used method finds a match, the user is granted access using that signature, otherwise not.

In some cases, presently available methods use the signature to grant access to a second stored signature, such as a certificate, which is then used for further operations. For example, a user can draw a pattern to unlock a certificate database, and either automatically or manually select a certificate to perform a task on a data processing system. In such cases as well, the initial signature remains reliant on a single input provided by the user.

The illustrative embodiments recognize that such methods of signature generation are inadequate for certain uses. Circumstances exist where more complex signatures are needed.

The illustrative embodiments used to describe the invention generally address and solve the above-described problems and other problems related to generating signatures. The illustrative embodiments provide a method, system, and computer program product for multi-component signature generation.

The illustrative embodiments use multiple data components to produce a complex signature. Not only is the resulting signature of an embodiment sufficiently complex to thwart guessing the signature, but an embodiment also employs a method of constructing the signature from several different components to deter reverse-engineering the signature.

The illustrative embodiments are described with respect to certain types of data, signature components, actions, events, and inputs only as examples. Such references are not intended to be limiting to the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

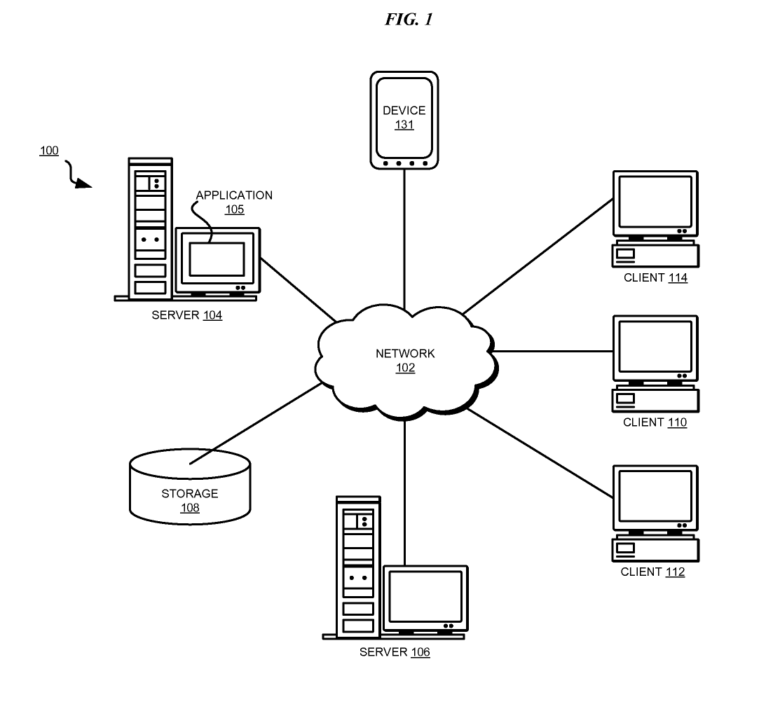

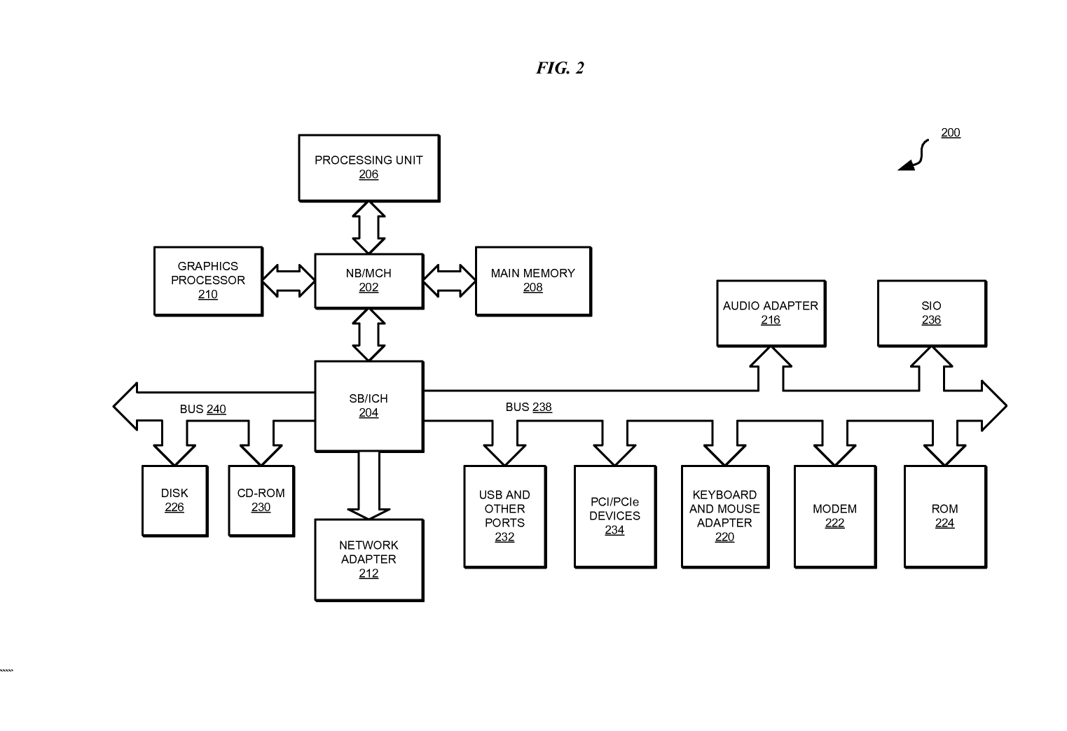

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, device 131 may be a portable computing device, such as a tablet computer, a smartphone, or an embedded computing device in another system such as in a vehicle. Device 131 is able to communicate with network 102 using wired or wireless communication. Application 105 in server 104 is an implementation of an embodiment described herein. Application 105 or a variation thereof can also execute in device 131 or another data processing system, such as client 114, to perform the operations of an embodiment and obtain corresponding results.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments.

Data processing system 200 is also representative of a computing device, such as device 131 in FIG. 1 in which computer usable program code or instructions implementing the processes of the illustrative embodiments may be located for the illustrative embodiments. Data processing system 200 is also representative of an embedded computing device, such as device 131 embedded in a vehicle (not shown) in which computer usable program code or instructions implementing the processes of the illustrative embodiments may be located for the illustrative embodiments. Data processing system 200 is described as a computer only as an example, without being limited thereto. Implementations in the form of device 131 in FIG. 1 may modify data processing system 200 and even eliminate certain depicted components there from without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive 226, CD-ROM 230, and other similarly usable devices are some examples of computer usable storage devices including computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

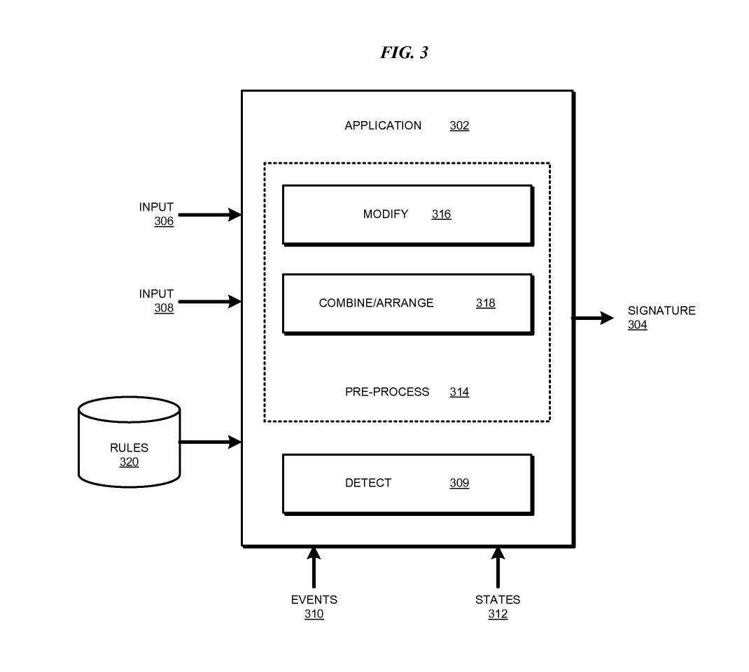

With reference to FIG. 3, this figure depicts a block diagram of an application for multi-component signature generation in accordance with an illustrative embodiment. Application 302 is an example of application 105 in FIG. 1.

Application 302 receives several pieces of data for use in constructing multi-component signature 304 according to an embodiment. Each piece of data is called a signature component because the piece is used in constructing multi-component signature 304.

Furthermore, application 302 can receive, detect, or even solicit a signature component. For example, inputs 306 and 308 can be inputs received in application 302 from a person, application, or a system. As an example, in one embodiment, input 306 can be a user-provided biometric input via an action, such as a fingerprint, a retina scan, a skin conductivity value, a breath analysis value, or any other suitable biometric input. Input 308 can be a text value entry, key press, gesture, pattern drawing, or any other suitable form of user-provided input.

In another embodiment, input 306 can be a symbolic or textual string supplied by an application or a system. Input 308 can be an image or scan received from a scanning or imaging device. Generally, any person, application, or system can act as a user for application 302 and supply any number of inputs, such as input 306 or 308, without limitation. Application 302 receives one or more inputs such as input 306 or 308 as signature components.

Using component 309, application 302 further detects or receives one or more events 310 as additional signature components. Events 310 include one or more events occurring in an application or a data processing system that communicate with application 302. Some examples of events can be, an instruction being executed, a computation completing successfully, a record becoming available for reading, data becoming ready for writing, a storage device coming online, an error condition existing on a network channel or adapter, utilization of a component exceeding a threshold, or any other event observed or observable in an application or a data processing system.

Using component 309, application 302 further detects or receives one or more states 312 as additional signature components. States 312 include one or more states observable for an application, process, thread, memory unit, component, subsystem, or a data processing system that communicate with application 302. Some examples of states can be a flag in memory, specific data in a location, or the status of a specific circuit or circuit component. Many other types of states observed or observable in an application or a data processing system are contemplated within the scope of the illustrative embodiments.

Application 302 includes preprocessing component 314. Preprocessing component 314 includes component 316 to modify a signature component. Component 316 is responsible for processing, transforming, changing, adapting, converting, or otherwise manipulating a received or detected signature component, such as input 306, event 310, or state 312.

Component 316 produces a set of modified signature components. The set of modified signature components can include modified form of some or all received or detected signature components.

Furthermore, component 316 can modify different signature components differently. In an example operation of one embodiment, using one or more rules from rules 320, component 316 translates input 306 from one representation to another, keeps input 308 unchanged or crops input 308, truncates one instance of events 310, concatenates another instance of events 310 with additional data, drops from consideration one state in states 312, and converts another state in states 312 to a different form. The example modification operations of component 316 are not intended to be limiting on the illustrative embodiments. Those of ordinary skill in the art will be able to conceive many other modifications of inputs, events, or states, and the same are contemplated within the scope of the illustrative embodiments.

Preprocessing component 314 further includes component 318 to combine or arrange a subset of the set of modified signature components. In one embodiment, component 318 combines or arranges all members of the set of modified signature components. In another embodiment, component 318 combines or arranges some members of the set of modified signature components.

As an example, in one embodiment, application 302 receives one instance of input 306, followed by one instance of event 310 detection, followed by input 308, followed by an instance of state 312 detection. Component 318 can also use additional inputs, events, or states that are not received or detected, but copied, derived, or computed from an input, event, or state present in the set of modified signature components. For example, in one embodiment, using one or more rules in rules 320, component 318 rearranges the signature components as two instances of input 306, followed by input 308, followed by one instance of event 310 simultaneously with the instance of state 312, followed by a modified instance of input 308. The re-arranged, combined, or reconfigured sequence of signature components, modified signature components, or a combination thereof, forms multi-component signature 304 according to an embodiment.

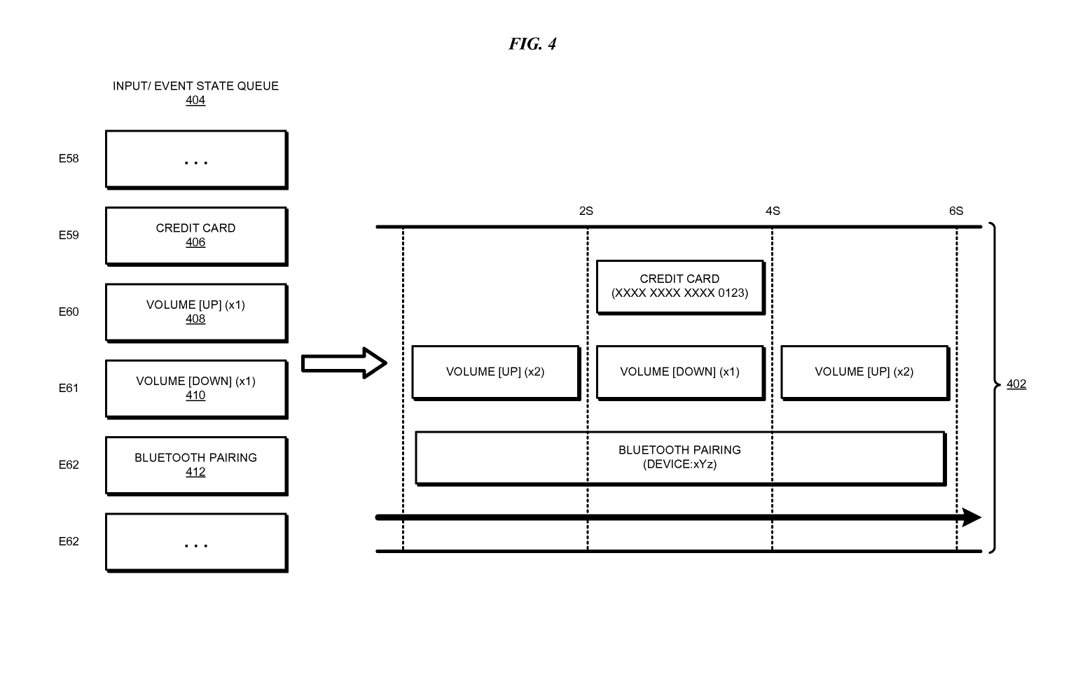

With reference to FIG. 4, this figure depicts an example multi-component signature generated from several inputs, events, and states in accordance with an illustrative embodiment. Multi-component signature 402 is an example of signature 304 in FIG. 3.

Queue 404 includes inputs, events, and states as received or detected during a period. For example, in example queue 404 during a given period, event 406 is a credit card swiped event, input 408 is a single press of the volume Up key or a single level increase in the audio volume using the volume Up key, input 410 is a single press of the volume Down key or a single level decrease in the audio volume using the volume Down key, and input 412 is a state indicating successful Bluetooth pairing with another device. The inputs, events, and states occurred in some temporal sequence as depicted in example queue 404.

An embodiment, such as in application 302 in FIG. 3, generates multi-component signature 402. As depicted, example signature 402 includes re-sequenced modified or original inputs, events, or states. For example, two presses of the volume Up key or a two-level increase in the audio volume using the volume Up key based on input 408 occurs in the first two seconds of the period of signature 402. A Bluetooth pairing state exists during these first two seconds.

A credit card swipe corresponding to event 406, and a single press of the volume Down key or a single level decrease in the audio volume using the volume Down key corresponding to input 410 occur during the next two seconds of the period of signature 402. The Bluetooth pairing state continues to exist during these next two seconds.

Two presses of the volume Down key or a two-level decrease in the audio volume using the volume Down key based on input 410 occurs in the last two seconds of the period of signature 402. The Bluetooth pairing state continues to exist during these last two seconds.

Thus, an embodiment generates an example multi-component signature in the form of signature 402 that spans six seconds, includes several signature components that use a combination of inputs, events, and states, in original or modified form, in an original or a re-arranged sequence.

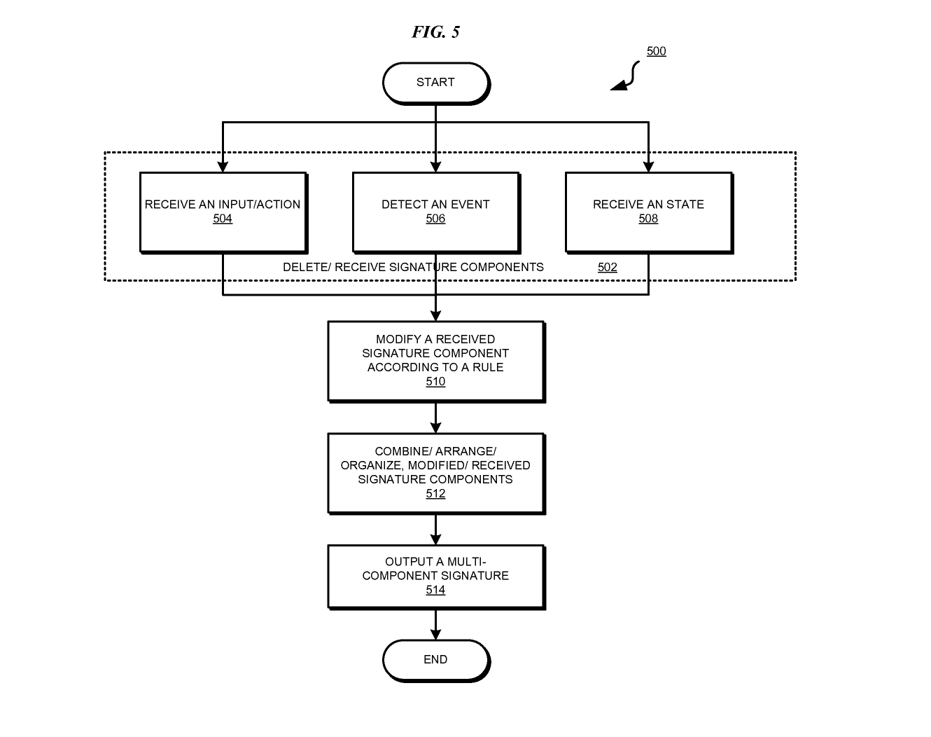

With reference to FIG. 5, this figure depicts a flowchart of an example process for multi-component signature generation in accordance with an illustrative embodiment. Process 500 can be implemented in application 302 in FIG. 3.

Process 500 begins by receiving one or more signature components (step 502). In performing step 502, process 500 receives one or more inputs or actions (step 504), detects one or more events (step 506), detects one or more states (step 508), or a combination thereof.

Process 500 modifies a received signature component according to a rule (step 510). The rule used in step 510 may be stored in a repository, such as in rules 320 in FIG. 3. In one embodiment, a user, such as an administrator, configures a logic or criterion for modifying an input, event, or state. For example, the administrator can use a graphical user interface to configure a rule. As another example, an application can configure a rule by storing code for executing rule logic to a rules repository. Generally, rules for modifying signature components and rearranging signature components in a multi-component signature can be configured in any suitable manner to achieve any suitable modification or sequencing within the scope of the illustrative embodiments.

Process 500 combines, arranges, organizes, or re-sequences original or modified signature components (step 512). Process 500 outputs a multi-component signature, such as signature 304 in FIG. 3 (step 514). Process 500 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for multi-component signature generation. A multi-component signature according to an embodiment can include one or more properties of presently available signatures, such as a complex alphanumeric string, that makes guessing the multi-component signature equally or more difficult as presently available signatures. Because the multi-component signature of an embodiment comprises several components created by receiving or detecting several signature components, modifying some or all such signature components, and then rearranging or re-sequencing some or all such signature components, the multi-component signature is also more difficult to reverse-engineer than a presently available signature. The multi-component signature is further difficult to reverse engineer because the multi-component signature comprises information from events or states of applications or systems, which can be system specific, time-sensitive, environment dependent, or have other such characteristics that are not easily duplicated or reproduced at a different time or place.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for multi-component signature generation, the method comprising:
receiving, at an application executing using a processor, a set of original signature components comprising original signature components of different types;
modifying a subset of original signature components from the set of original signature components to create a set of modified signature components;
arranging members of a subset of the set of modified signature components in a modified order, wherein the modified order is different from an original order in which original signature components corresponding to the members of the subset of the set of modified signature components appear in the set of original signature components; and
generating, responsive to the arranging, the multi-component signature.

2. The method of claim 1, wherein the arranging further comprises:
including a member of the set of original signature components in the modified order.

3. The method of claim 1, wherein the modifying comprises:
changing a number of occurrences of a first original signature component.

4. The method of claim 1, wherein the modifying comprises:
changing an effect of a first original signature component.

5. The method of claim 1, wherein the modifying comprises:
translating a first original signature component.

6. The method of claim 1, wherein the modifying comprises:
changing a type of a first original signature component.

7. The method of claim 1, wherein the modifying comprises:
changing a size of a first original signature component.

8. The method of claim 1, wherein the modifying comprises:
selecting a part of a first original signature component.

9. The method of claim 1, wherein the modifying comprises:
excluding a first original signature component.

10. The method of claim 1, wherein a signature component in the set of original signature components comprises an input provided by a user and another signature component in the set of original signature components comprises an event detected in a data processing system where the application is executing.

11. The method of claim 1, wherein the set of original signature components includes a key press and an event observed in a data processing system where the application is executing.

12. A computer usable program product comprising a computer usable storage device including computer usable code for multi-component signature generation, the computer usable code comprising:
computer usable code for receiving, at an application executing using a processor, a set of original signature components comprising original signature components of different types;
computer usable code for modifying a subset of original signature components from the set of original signature components to create a set of modified signature components;
computer usable code for arranging members of a subset of the set of modified signature components in a modified order, wherein the modified order is different from an original order in which original signature components corresponding to the members of the subset of the set of modified signature components appear in the set of original signature components; and
computer usable code for generating, responsive to the arranging, the multi-component signature.

13. The computer usable program product of claim 12, wherein the computer usable code for arranging further comprises:
computer usable code for including a member of the set of original signature components in the modified order.

14. The computer usable program product of claim 12, wherein the computer usable code for modifying comprises:
computer usable code for changing a number of occurrences of a first original signature component.

15. The computer usable program product of claim 12, wherein the computer usable code for modifying comprises:
computer usable code for changing an effect of a first original signature component.

16. The computer usable program product of claim 12, wherein the computer usable code for modifying comprises:
computer usable code for translating a first original signature component.

17. The computer usable program product of claim 12, wherein the computer usable code for modifying comprises:
computer usable code for changing a type of a first original signature component.

18. The computer usable program product of claim 12, wherein the computer usable code is stored in a computer readable storage medium in a data processing system, and wherein the computer usable code is transferred over a network from a remote data processing system.

19. The computer usable program product of claim 12, wherein the computer usable code is stored in a computer readable storage medium in a server data processing system, and wherein the computer usable code is downloaded over a network to a remote data processing system for use in a computer readable storage medium associated with the remote data processing system.

20. A data processing system for multi-component signature generation, the data processing system comprising:
a storage device including a storage medium, wherein the storage device stores computer usable program code; and
a processor, wherein the processor executes the computer usable program code, and wherein the computer usable program code comprises:
computer usable code for receiving, at an application executing using a processor, a set of original signature components comprising original signature components of different types;
computer usable code for modifying a subset of original signature components from the set of original signature components to create a set of modified signature components;
computer usable code for arranging members of a subset of the set of modified signature components in a modified order, wherein the modified order is different from an original order in which original signature components corresponding to the members of the subset of the set of modified signature components appear in the set of original signature components; and
computer usable code for generating, responsive to the arranging, the multi-component signature.
